(19) United States
(12) Patent Application Publication
(10) Pub. No.: US 2026/0107224 A1
(43) Pub. Date: Apr. 16, 2026

(54) METHOD FOR TARGET WAKE TIME AND ELECTRONIC DEVICE FOR PERFORMING THE SAME

(71) Applicant: Samsung Electronics Co., Ltd., Suwon-si (KR)

(72) Inventor: Junsu CHOI, Suwon-si (KR)

(21) Appl. No.: 19/333,945

(22) Filed: Sep. 19, 2025

Related U.S. Application Data
(63) Continuation of application No. PCT/KR2025/009920, filed on Jul. 9, 2025.

(30) Foreign Application Priority Data
Oct. 10, 2024 (KR) 10-2024-0137629
Nov. 4, 2024 (KR) 10-2024-0154721

(51) Int. Cl. H04W 52/02; H04W 74/0816

(52) U.S. Cl. CPC H04W 52/0216; H04W 74/0816

(57) ABSTRACT

A method performed by an electronic device includes: transmitting, to an external electronic device broadcasting a wireless fidelity (Wi-Fi) signal, a TWT request frame to determine a transmission opportunity (TXOP) limit of another client device in a basic service set (BSS) including the external electronic device and the electronic device communicatively connected to the external electronic device and receiving, from the external electronic device, a TWT response frame corresponding to the TWT request frame.

### CROSS-REFERENCE TO RELATED APPLICATIONS

This application is a continuation of International Application No. PCT/KR2025/009920 designating the United States, filed on Jul. 9, 2025, in the Korean Intellectual Property Receiving Office and claiming priority to Korean Patent Application No. 10-2024-0137629, filed on Oct. 10, 2024, and Korean Patent Application No. 10-2024-0154721, filed on Nov. 4, 2024, in the Korean Intellectual Property Office, the disclosures of each of which are incorporated by reference herein in their entireties.

### BACKGROUND

### 1. Field

The disclosure relates to a method for a target wake time (TWT) and an electronic device for performing the same.

### 2. Description of Related Art

In a wireless fidelity (Wi-Fi) network, it may be important to satisfy the quality of service (QoS) requirements of an application (or a service) for the user's experience or performance of an application.

The QoS requirements may be network performance conditions required for an application (or traffic). For example, a virtual reality (VR) application or an augmented reality (AR) application may have higher QoS requirements than a web browsing application (e.g., Google Chrome).

The above information may be presented as the related art to help with the understanding of the disclosure. No assertion or determination is made as to whether any of the above description is applicable as the prior art related to the present disclosure.

### SUMMARY

According to various example embodiments, an electronic device includes: at least one processor, including processing circuitry, and memory storing instructions. At least one processor, individually or collectively, may be configured to execute the instructions and to cause the electronic device to: transmit, to an external electronic device broadcasting a wireless fidelity (Wi-Fi) signal, a target wake time (TWT) request frame to determine a transmission opportunity (TXOP) limit of another client device in a basic service set (BSS) including the external electronic device and the electronic device communicatively connected to the external electronic device; and receive, from the external electronic device, a TWT response frame corresponding to the TWT request frame.

According to various example embodiments, an electronic device for broadcasting a Wi-Fi signal includes: at least one processor, including processing circuitry, and memory storing instructions. At least one processor, individually or collectively, may be configured to execute the instructions and to cause the electronic device to: receive, from an external electronic device communicatively connected to the electronic device, a TWT request frame to determine a TXOP limit of another client device in a BSS including the electronic device and the external electronic device; and transmit, to the external electronic device, a TWT response frame corresponding to the TWT request frame.

According to various example embodiments, a method performed by an electronic device includes: transmitting, to an external electronic device broadcasting a Wi-Fi signal, a TWT request frame to determine a TXOP limit of another client device in a BSS including the external electronic device and the electronic device communicatively connected to the external electronic device; and receiving, from the external electronic device, a TWT response frame corresponding to the TWT request frame.

According to various example embodiments, a non-transitory computer-readable storage medium storing one or more computer programs may include instructions that cause at least one processor, comprising processing circuitry, to individually and/or collectively, perform the method.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIGS. 1 and 2 are diagrams illustrating a wireless local area network (WLAN) system according to various embodiments;

FIG. 3 is a signal flow diagram illustrating an example of a link setup operation, according to various embodiments;

FIG. 4 is a diagram illustrating an example carrier sense multiple access with collision avoidance (CSMA/CA) protocol according to various embodiments;

FIG. 5 is a diagram illustrating example access category-based quality of service (QoS) control according to various embodiments;

FIG. 6 is a diagram illustrating example transmission latency according to various embodiments;

FIG. 7 is a diagram illustrating example target wake time (TWT) according to various embodiments;

FIG. 8 is a signal flow diagram illustrating example TWT negotiation according to various embodiments;

FIG. 9 is a diagram illustrating an example transmission opportunity (TXOP) limit according to various embodiments;

FIG. 10 is a diagram illustrating an example TWT request frame according to various embodiments;

FIG. 11 is a diagram illustrating an example TWT element according to various embodiments;

FIG. 12 is a diagram illustrating an example TWT control field of a TWT element according to various embodiments;

FIG. 13 is a diagram illustrating an example QoS characteristic element according to various embodiments;

FIG. 14 is a flowchart illustrating an example process of determining a TXOP limit, according to various embodiments;

FIG. 15 is a diagram illustrating an example process of processing a plurality of TWT requests, according to various embodiments;

FIG. 16 is a flowchart illustrating an example method performed by an electronic device that operates as a client, according to various embodiments;

FIG. 17 is a flowchart illustrating an example method performed by an electronic device that operates as an access point (AP), according to various embodiments; and

FIG. 18 is a block diagram illustrating an example electronic device in a network environment, according to various embodiments.

### DETAILED DESCRIPTION

Hereinafter, various example embodiments will be described in greater detail with reference to the accompanying drawings. When describing the disclosure with reference to the accompanying drawings, like reference numerals refer to like elements and a repeated description related thereto may be omitted.

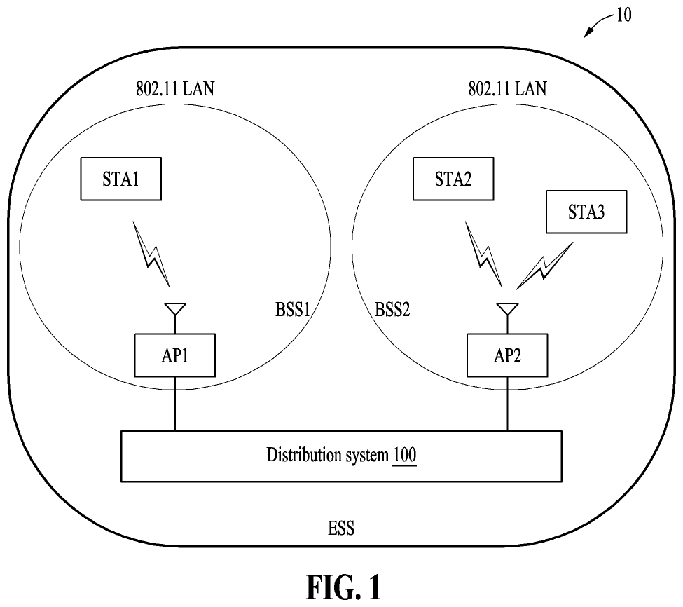

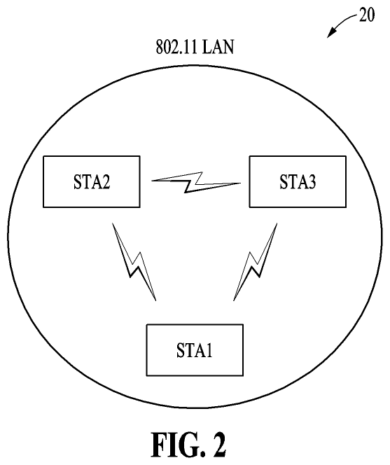

FIGS. 1 and 2 are diagrams illustrating an example wireless local area network (WLAN) system according to various embodiments.

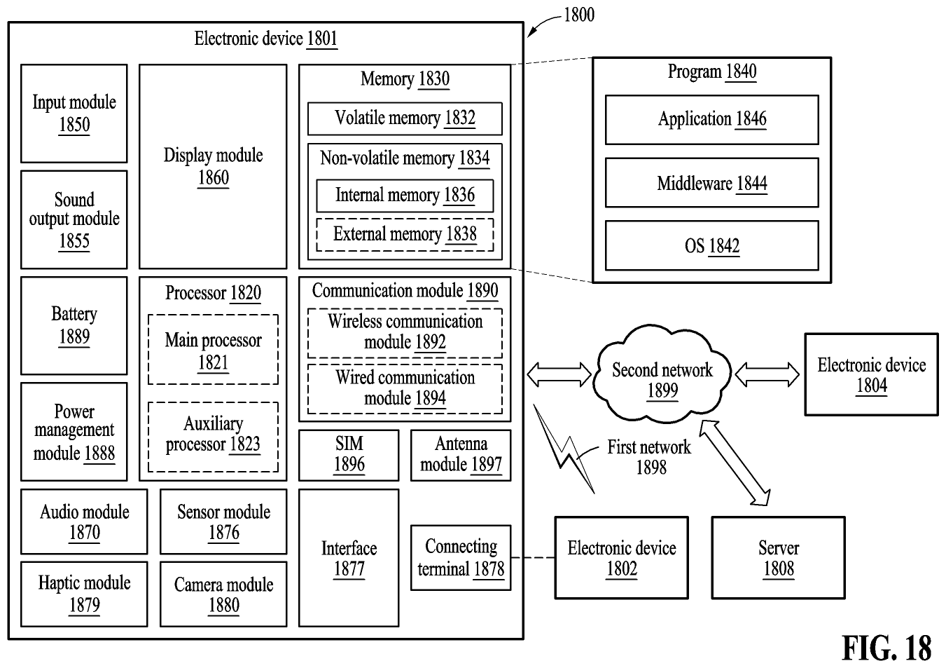

Referring to FIG. 1, according to an embodiment, a WLAN system 10 may refer to an infrastructure mode in which an access point (AP) is present in the structure of a WLAN of the Institute of Electrical and Electronic Engineers (IEEE) 802.11 standard. The WLAN system 10 may include one or more basic service sets (BSSs) (e.g., BSS1 and BSS2). The BSS (e.g., BSS1 or BSS2) may refer to a set of APs (e.g., an electronic device 1802 and an electronic device 1804 of FIG. 18) and stations (STAs) (e.g., an electronic device 1801 of FIG. 18) that may communicate with each other with a successful synchronization. The BSS1 may include an AP1 and an STA1, and the BSS2 may include an AP2, an STA2, and an STA3.

According to an embodiment, the WLAN system 10 may include at least one STA (e.g., STA1 to STA3), a plurality of APs (e.g., AP1 and AP2) providing a distribution service, and a distribution system 100 connecting the plurality of APs (e.g., AP1 and AP2). The distribution system 100 may implement an extended service set (ESS) by connecting a plurality of BSSs (e.g., BSS1 and BSS2). The ESS may be used as a term referring to one network in which the plurality of APs (e.g., AP1 and AP2) are connected through the distribution system 100. The plurality of APs (e.g., AP1 and AP2) included in one ESS may have the same service set identification (SSID).

According to an embodiment, the STA (e.g., STA1 to STA3) may be an arbitrary functional medium including a medium access control (MAC) and a physical layer interface for a wireless medium that conform to the provisions of the IEEE 802.11 standard. The term “STA” (e.g., STA1 to STA3) may be used as including both an AP and a non-AP STA. The STA (e.g., STA1 to STA3) may be referred to by various names, such as, an electronic device, a mobile terminal, a wireless device, a wireless transmit/receive unit (WTRU), user equipment (UE), a mobile station (MS), a mobile subscriber unit, or simply, a user.

Referring to FIG. 2, according to an embodiment, a WLAN system 20 may represent an ad-hoc mode in which a network is established and communicated between a plurality of STAs (e.g., STA1 to STA3) without any AP in the structure of a WLAN of the IEEE 802.11 standard, as opposed to the WLAN system 10 of FIG. 1. The WLAN system 20 may include a BSS operating in an ad-hoc mode, that is, an independent basic service set (IBSS).

According to an embodiment, since the IBSS may not include an AP, a centralized management entity that performs a management function at the center may not exist. In the IBSS, STAs may be managed in a distributed manner. In the IBSS, all STAs may be mobile STAs, and access to a distribution system may not be allowed so that the IBSS may form a self-contained network.

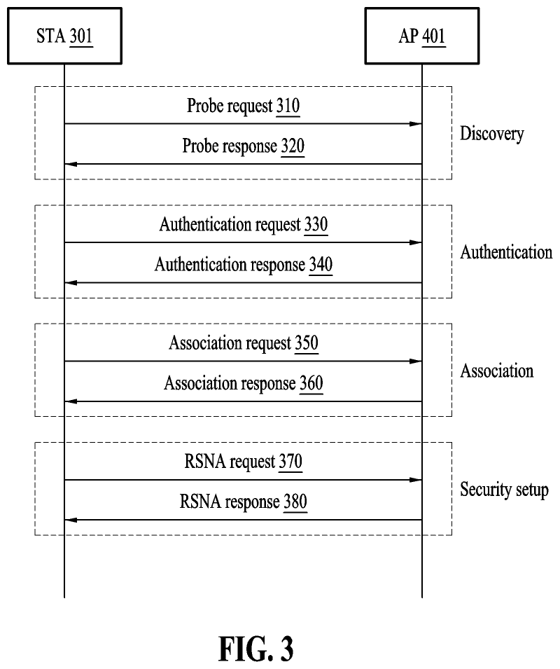

FIG. 3 is a signal flow diagram illustrating an example of a link setup operation, according to various embodiments.

Referring to FIG. 3, according to an embodiment, the link setup operation may be performed between devices (e.g., an STA 301 and an AP 401) to communicate with each other. For link setup, a network may be discovered, authentication may be performed, association may be established, and a setup operation for security may be performed. The link setup operation may be referred to as a session initiation operation or a session setup operation. Furthermore, the operations of discovery, authentication, association, and setting security of the link setup operation may be collectively referred to as an association operation.

According to an embodiment, the network discovery operation may include operation 310 and operation 320. In operation 310, the STA 301 (e.g., the electronic device 1801 of FIG. 18) may transmit a probe request frame to probe which AP (e.g., the electronic device 1802 or the electronic device 1804 of FIG. 18) exists and may wait for a response to the probe request frame. The STA 301 may find a network to participate in by performing a scanning operation to access the network. The probe request frame may include information of the STA 301 (e.g., a device name and/or address of the STA 301). The scanning operation in operation 310 may refer to an active scanning operation. In operation 320, the AP 401 may transmit a probe response frame to the STA 301 that has transmitted the probe request frame, in response to the probe request frame. The probe response frame may include information of the AP 401 (e.g., a device name and/or network information of the AP 401). While FIG. 3 illustrates that the network discovery operation is performed through active scanning, the disclosure is not necessarily limited thereto. In case that the STA 301 performs passive scanning, the operation of transmitting the probe request frame may be omitted. The STA 301 that performs passive scanning may receive a beacon frame transmitted by the AP 401 and perform the following subsequent procedures.

According to an embodiment, after the STA 301 discovers the network, an authentication operation including operation 330 and operation 340 may be performed. In operation 330, the STA 301 may transmit an authentication request frame to the AP 401. In operation 340, the AP 401 may determine whether to allow authentication for the corresponding STA 301 based on information contained in the authentication request frame. The AP 401 may provide a result of the authentication processing to the STA 301 via an authentication response frame. An authentication frame used for authentication request/response may correspond to a management frame.

According to an embodiment, the authentication frame may include information about an authentication algorithm number, an authentication transaction sequence number, a status code, a challenge text, a robust security network (RSN), or a finite cyclic group.

According to an embodiment, after successful authentication of the STA 301, an association operation including operation 350 and operation 360 may be performed. In operation 350, the STA 301 may transmit an association request frame to the AP 401. In operation 360, the AP 401 may transmit an association response frame to the STA 301, in response to the association request frame.

According to an embodiment, the association request frame and/or the association response frame may include information related to various capabilities. For example, the association request frame may include information related to various capabilities, a beacon listening interval, a service set identifier (SSID), supported rates, supported channels, an RSN, a mobility domain, supported operating classes, a traffic indication map (TIM) broadcast request, and/or information related to an interworking service capability. For example, the association response frame may include information related to various capabilities, a status code, association ID (AID), supported rates, an enhanced distributed channel access (EDCA) parameter set, a received channel power indicator (RCPI), a received signal-to-noise indicator (RSNI), a mobility domain, a timeout interval (e.g., an association comeback time), an overlapping BSS scan parameter, a TIM broadcast response, and/or information such as a quality of service (QoS) map.

According to an embodiment, after the STA 301 is successfully associated with the network, a security setup operation including operation 370 and operation 380 may be performed. The security setup operation may be performed through a robust security network association (RSNA) request/response. For example, the security setup operation may include an operation of performing private key setup by means of a 4-way handshaking through an extensible authentication protocol over LAN (EAPOL) frame. The security setup operation may be performed using another security scheme that is not defined in the IEEE 802.11 standard.

According to an embodiment, a security session may be established between the STA 301 and the AP 401 according to the security setup operation, and the STA 301 and the AP 401 may proceed with secure data communication.

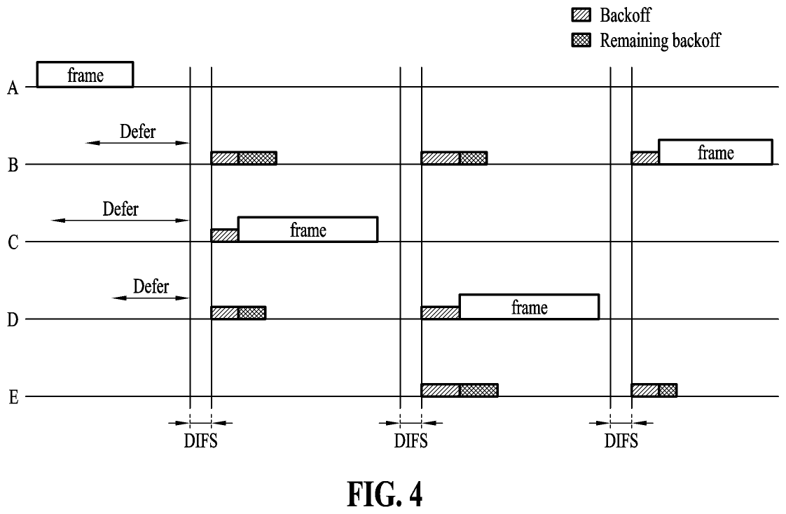

FIG. 4 is a diagram illustrating example carrier sense multiple access with collision avoidance (CSMA/CA) protocol according to various embodiments. FIG. 4 may illustrate the CSMA/CA protocol to prevent/reduce a data collision between a plurality of client devices A to E (e.g., the STA 301 of FIG. 3) connected to an AP (e.g., the AP 401 of FIG. 3).

Referring to FIG. 4, according to an embodiment, the client devices A to E may be included in the same BSS. The client devices A to E may share a channel (e.g., a channel in the 2.4 gigahertz (GHz), 5 GHz, or 6 GHz band) for data transmission.

According to an embodiment, each of the client devices A to E may determine whether the channel is being used before transmitting data (e.g., a frame). Each of the client devices A to E may defer its own data transmission while the channel is being used for data transmission of another client device.

According to an embodiment, each of the client devices A to E may have to wait for a waiting time, which is called a distributed inter-frame space (DIFS), before transmitting data. The DIFS may be the minimum waiting time that is commonly applied to the client devices A to E.

According to an embodiment, each of the client devices A to E may prevent/reduce a data collision with the other client device using a backoff (or a backoff timer). The backoff may be a random waiting time set to prevent/reduce the client devices A to E from transmitting data simultaneously.

According to an embodiment, each of the client devices A to E may count the set backoff timer while the channel is not being used by the other client device. Each of the client devices A to E may stop counting the backoff timer while the channel is being used by the other client device. Each of the client devices A to E may initiate data transmission when its own backoff timer becomes ‘0.’

According to an embodiment, when respective applications executed by the client devices A to E are different, a protocol to satisfy the QoS requirements of each of the client devices A to E may be required. For example, when an augmented reality (AR) application is being executed by the client device A and a web browsing application is being executed by the client device B, the respective QoS requirements for the client device A and the client device B may be different from each other.

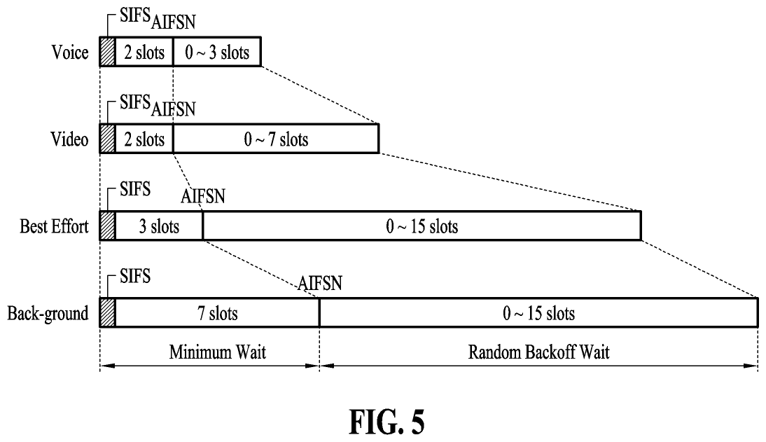

FIG. 5 is a diagram illustrating example access category-based QoS management according to various embodiments.

Referring to FIG. 5, the QoS for various traffic types may be guaranteed using an access category to satisfy different QoS requirements. The access category may be a concept defined to determine the priority of network traffic in the wireless fidelity (Wi-Fi) standard.

According to an embodiment, for media access control of traffic, a waiting time determined based on a short interframe space (SIFS), an arbitration interframe space number (AIFSN), and a random backoff may be used.

According to an embodiment, the random backoff of traffic may be randomly determined within a backoff range. For example, a random backoff of voice may be a value between 0 slots and 3 slots.

According to an embodiment, since the respective priorities of voice, video, best effort, and background are different from each other, the AIFSN and backoff range determined based on the priority may be used to satisfy the QoS. For example, a voice with the highest priority may have a relatively smaller AIFSN and narrower backoff range than a background with the lowest priority. Traffic with a relatively high priority may wait for a relatively shorter waiting time for media access (or media occupancy) than traffic with a relatively low priority, through the AIFSN and backoff range.

According to an embodiment, since the waiting time for medium access is applied based on the priority of traffic, the higher the priority of traffic, the higher the probability that the traffic wins the contention for medium access.

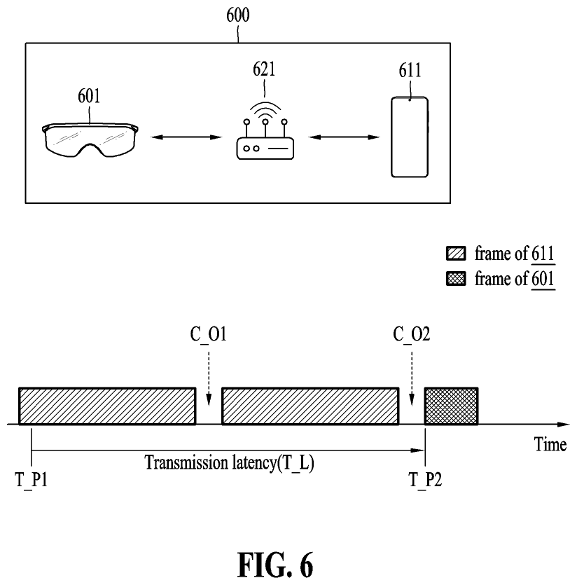

FIG. 6 is a diagram illustrating example transmission latency according to various embodiments. FIG. 6 may illustrate a transmission latency that may occur in a Wi-Fi network 600 to which access category-based QoS control is applied. For ease of description, medium access control in the Wi-Fi network 600 in which two client devices 601 and 611 are connected to an AP 621 is described herein, but the scope of the present disclosure is not limited thereto.

Referring to FIG. 6, according to an embodiment, the client devices 601 and 611 (e.g., the STA 301 of FIG. 3) communicatively connected to the AP 621 may contend with each other for medium access (or medium occupancy). The respective QoS requirements of the contending client devices 601 and 611 may be different from each other. For example, a virtual reality (VR) application may be executed by the client device 601 and a web browsing application may be executed by the client device 611.

According to an embodiment, in the Wi-Fi network 600, when the client device 601 drives an application (or a service) with a relatively higher priority than the client device 611, the client device 601 may access a medium (or occupy a medium) with a higher probability than the client device 611. After a time point T_P1 when a frame (or a data packet) of the client device 601 is added to a transmission queue, the client device 601 and the client device 611 may contend for medium access (or medium occupancy). The client device 601 may win the contention with a higher probability than the client device 611, but a high winning probability may not guarantee that the client device 601 definitively beats the client device 611. For example, when the client device 601 loses a first contention C_O1 and wins a second contention C_O2, a transmission latency T_L corresponding to a time interval between two time points T_P1 and T_P2 may occur. The longer the frame of the client device 611, the longer the client device 601 may have to wait to obtain the next contention opportunity, and accordingly, the transmission latency T_L may also be longer. The long transmission latency T_L may lead to degradation of a user's experience.

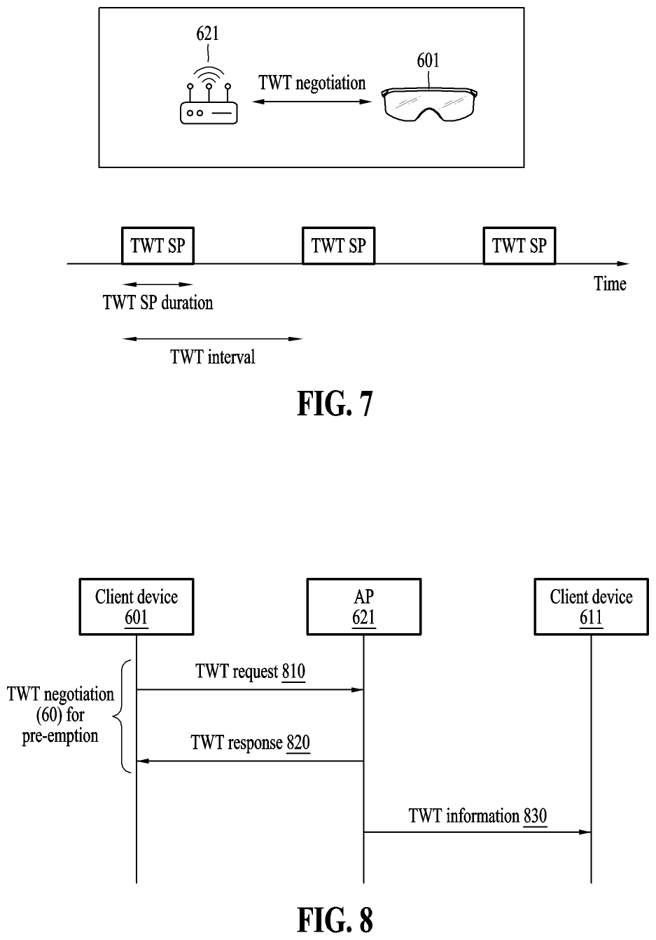

FIG. 7 is a diagram illustrating an example target wake time (TWT) according to various embodiments.

Referring to FIG. 7, according to an embodiment, in a Wi-Fi communication network, a TWT mechanism (or a function) may be used to reduce the power consumption of a Wi-Fi device or improve network connectivity.

The client device 601 may determine a TWT parameter, such as a TWT service period (SP), a TWT SP duration, or a TWT interval, through a traditional TWT negotiation (e.g., an individual TWT or a broadcast TWT) defined in the Wi-Fi standard. The TWT SP may be a time period during which the client device 601 is awake for data transmission.

Even when the negotiation for the TWT SP between the client device 601 and the AP 621 is made, another contending client device (e.g., the client device 611 of FIG. 6) may participate in contention for medium occupancy during the TWT SP of the client device 601, so the traditional TWT negotiation may not be a sufficient solution to satisfy the QoS requirement of the client device 601.

FIG. 8 is a signal flow diagram illustrating example TWT negotiation according to various embodiments.

Referring to FIG. 8, according to an embodiment, operations 810, 820 and 830 may be performed sequentially but are not limited thereto. For example, operations 820 and 830 may be performed in parallel.

In operation 810, the client device 601 may transmit a TWT request frame to the AP 621 to initiate a TWT negotiation 60 for pre-emption. The TWT negotiation 60 may be for determining (or limiting) a transmission opportunity (TXOP) limit of the other client device 611 during (or within) a TWT SP of the client device 601 to satisfy the QoS requirement of the client device 601. The TXOP limit may indicate, in a Wi-Fi network, the maximum amount of time during which a Wi-Fi device may consecutively transmit data.

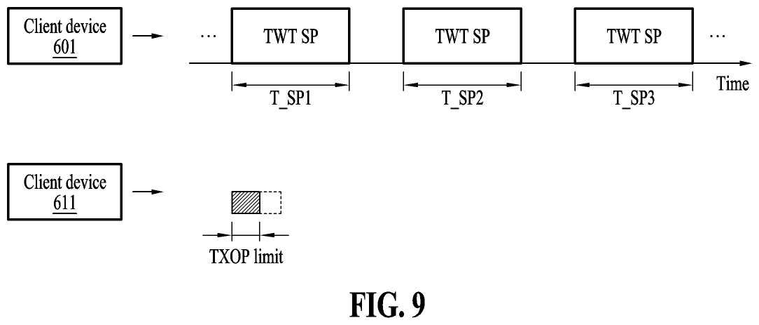

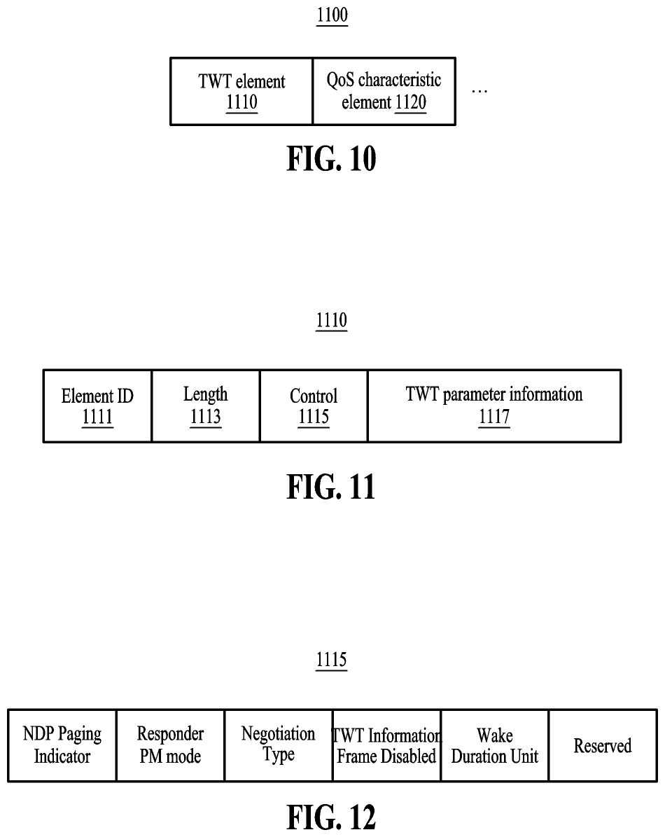

According to an embodiment, if necessary, the TWT negotiation 60 may also perform a function of the traditional TWT negotiation (e.g., an individual TWT or a broadcast TWT). For example, before the TWT negotiation 60 is initiated, when a completed TWT negotiation (e.g., an individual TWT) does not currently exist between the client device 601 and the AP 621, the TWT negotiation 60 may be performed to determine a TWT schedule (e.g., a TWT SP, a TWT SP duration, and/or a TWT interval) of the client device 601 and the TXOP limit of the other client device 611. The TWT negotiation 60 is described in detail with reference to FIG. 9, and the TWT request frame is described in detail with reference to FIG. 10.

In operation 820, the AP 621 may transmit, to the client device 601, a TWT response frame for the TWT request frame received from the client device 601. The TWT request frame may include information for accepting the TWT request from the client device 601 and/or information for modifying at least a portion of the TWT request. In FIG. 8, the TWT negotiation 60 is illustrated as being completed via one TWT request and one TWT response, but this is an example for ease of description, and a plurality of TWT requests and a plurality of TWT responses may be required to complete the TWT negotiation 60. For example, when the AP 621 modifies the TWT information (e.g., a modified TWT parameter) included in the TWT request frame of the client device 601 and transmits, to the client device 601, the TWT response frame including the modified TWT information but the client device 601 does not accept the modified TWT information, an additional TWT request and an additional TWT response may be required.

In operation 830, the AP 621 may provide information about the TWT negotiation 60 to the other client device 611 contending with the client device 601 for medium access (or medium occupancy). For example, the AP 621 may provide, to the other client device 601, the TXOP limit of the other client device 611, determined by the TWT negotiation 60 of the client device 601. For example, the AP 621 may provide, to the other client device 611, information about the TWT negotiation 60 with the client device 601 through a beacon frame.

FIG. 9 is a diagram illustrating an example TXOP limit according to various embodiments.

Referring to FIG. 9, according to an embodiment, the TXOP limit of the other client device 611 may be determined through a TWT negotiation (e.g., the TWT negotiation 60 of FIG. 8) for pre-emption of the client device 601.

According to an embodiment, as the TXOP limit of the other client device 611 is limited during (or within) a TWT SP (e.g., at least one of the TWT SPs (T_SP1, T_SP2, and T_SP3)) of the client device 601, the client device 601 may be provided with a greater number of contending opportunities during the TWT SP. For example, the client device 601 may be given more opportunities to contend with the other client device 611 when the TXOP limit of the other client device 611 is 0.5 milliseconds (ms), than when the TXOP limit of the other client device 611 is 1 ms. As the client device 601 is given a greater number of contending opportunities, the probability that the client device 601 transmits data (or a frame) within a specific time period may increase. For example, when the client device 601 is given three contention opportunities during 5 ms, the probability that the client device 601 transmits data during 5 ms may be higher than when the client device 601 is given one contention opportunity during 5 ms.

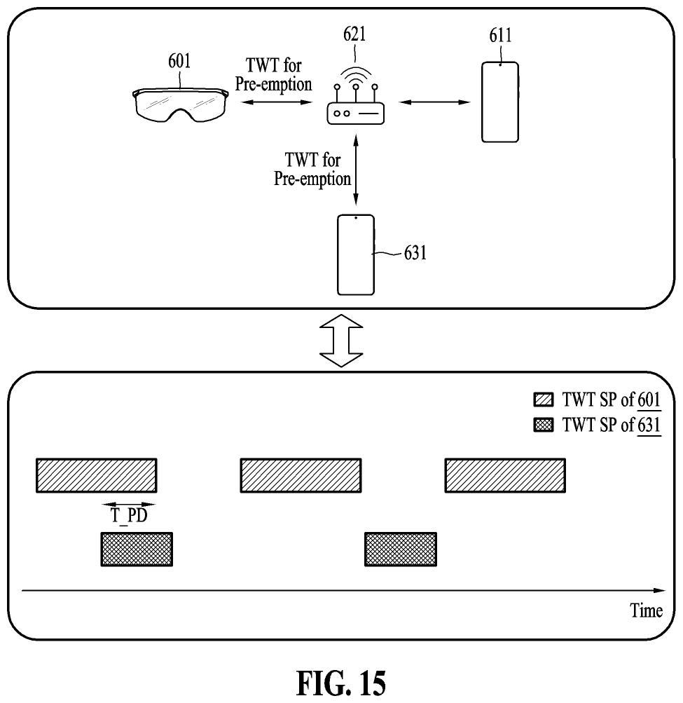

The process of determining the TXOP limit is described in greater detail below with reference to FIG. 15.

FIG. 10 is a diagram illustrating an example TWT request frame according to various embodiments.

Referring to FIG. 10, according to an embodiment, a client device (e.g., the client device 601 of FIG. 8 or 9) may transmit a TWT request frame 1100 to an AP (e.g., the AP 621 of FIG. 8) for a TWT negotiation (e.g., the TWT negotiation 60 of FIG. 8) for pre-emption.

According to an embodiment, the TWT request frame 1100 may include a TWT element 1110 and a QoS characteristic element 1120. If necessary, the TWT element 1110 or the QoS characteristic element 1120 may be excluded from the TWT request frame 1100. For example, when the AP 621 obtains the QoS characteristic element 1120 of the client device 601 through a previous TWT request frame, the next TWT request frame transmitted from the client device 601 to the AP 621 may not include the QoS characteristic element 1120.

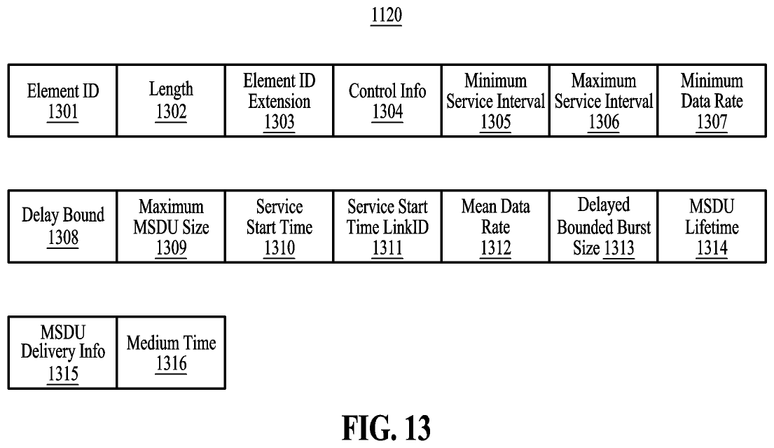

The TWT element 1110 is described in greater detail below with reference to FIG. 11 or 12, and the QoS characteristic element 1120 is described in greater detail below with reference to FIG. 13.

FIG. 11 is a diagram illustrating an example TWT element according to various embodiments, and FIG. 12 is a diagram illustrating an example TWT control field of a TWT element, according to various embodiments.

Referring to FIG. 11, according to an embodiment, the TWT element 1110 may include Element ID 1111, Length 1113, Control 1115, and TWT parameter information 1117. FIG. 11 is an example of the TWT element 1110, and the TWT element 1110 may include only some of the plurality of fields 1111 to 1117 or may include at least one additional field.

According to an embodiment, the Element ID 1111 may be a field including information to identify the TWT element 1110.

According to an embodiment, the Length 1113 may be a field including information about the total length of the TWT element 1110.

According to an embodiment, the Control 1115 may be a field including information to control TWT operations or TWT schedules. The Control 1115 is described in greater detail below with reference to FIG. 12.

According to an embodiment, the TWT parameter information 1117 may include information about a TWT parameter. For example, the TWT parameter information 1117 may include a TWT wake time, a TWT interval, and/or TWT SP duration.

Referring to FIG. 12, according to an embodiment, a client device (e.g., the client device 601 of FIG. 8 or 9) that desires to initiate a TWT negotiation (e.g., the TWT negotiation 60 of FIG. 8) for pre-emption may inform an AP (e.g., the AP 621 of FIG. 8 or 9) of information about a type of the TWT negotiation 60 for pre-emption through the Control 1115. For example, the client device 601 may record information indicating that a TWT request is for the TWT negotiation 60 for pre-emption, not the traditional TWT negotiation (e.g., an individual TWT or a broadcast TWT), in a reserved field of the Control 1115, and transmit, to the AP 621, a TWT request frame (e.g., the TWT request frame 1100 of FIG. 10) including the reserved field.

FIG. 13 is a diagram illustrating an example QoS characteristic element according to various embodiments.

Referring to FIG. 13, according to an embodiment, a client device (e.g., the client device 601 of FIG. 8 or 9) may provide the QoS characteristic element 1120 to an AP (e.g., the AP 621 of FIG. 8 or 9) for a TWT negotiation (e.g., the TWT negotiation 60 of FIG. 8) for pre-emption.

According to an embodiment, the QoS characteristic element 1120 may include a plurality of fields 1301 to 1316. FIG. 13 is an example of the QoS characteristic element 1120, and the QoS characteristic element 1120 may include only some of the fields 1301 to 1316 or may further include a new field (not shown) related to QoS information.

According to an embodiment, Element ID 1301 may include information to identify the QoS characteristic element 1120.

According to an embodiment, Length 1302 may include information about the total length of the QoS characteristic element 1120.

According to an embodiment, Element ID Extension 1303 may include information to identify the QoS characteristic element 1120 separately from the Element ID 1301.

According to an embodiment, Control Info 1304 may include information to define the QoS requirement.

According to an embodiment, Minimum Service Interval 1305 may include information about the minimum time interval between two SPs.

According to an embodiment, Maximum Service Interval 1306 may include information about the maximum time interval between two SPs.

According to an embodiment, Minimum Data Rate 1307 may include information about the minimum data rate that must be provided for traffic.

According to an embodiment, Delay Bound 1308 may include information about an allowable maximum transmission latency for traffic. An application that generates traffic with a high priority, such as a real-time application (e.g., a voice call), may have a relatively low delay bound value.

According to an embodiment, Maximum media access control service data unit (MSDU) size 1309 may include information about the maximum size of a data frame that may be transmitted.

According to an embodiment, Service Start Time 1310 may include information about the start time of a service.

According to an embodiment, Service Start Time LinkID 1311 may include information to manage a plurality of services and start times of the plurality of services when the plurality of services exists in a Wi-Fi network.

According to an embodiment, Mean Data Rate 1312 may include information about an average data transmission rate required for traffic.

According to an embodiment, Delayed Bound Burst Size 1313 may include information about the maximum size of data that may be transmitted at a time when a latency is allowed.

According to an embodiment, MSDU Lifetime 1314 may include information about the time length during which a data packet may be validly treated in the Wi-Fi network.

According to an embodiment, MSDU Delivery Info 1315 may include information about specific requirements required for data transmission.

According to an embodiment, Time 1316 may include information about the time when a medium may be occupied for data transmission.

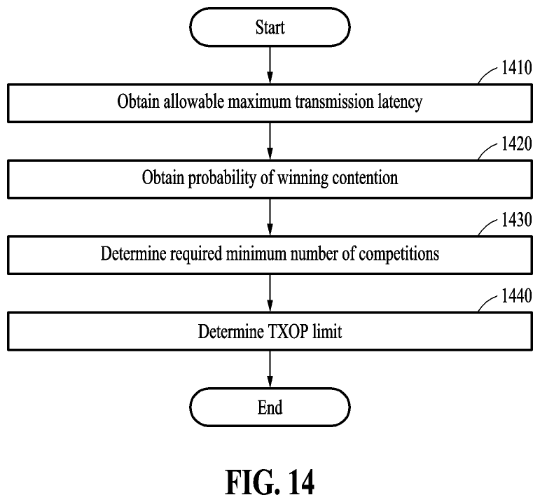

FIG. 14 is a flowchart illustrating an example process of determining a TXOP limit, according to various embodiments.

Referring to FIG. 14, according to an embodiment, operations 1410 to 1440 may be performed sequentially but are not limited thereto. For example, operations 1410 and 1420 may be performed in parallel, or operation 1420 may be performed before operation 1410.

In operation 1410, an AP (e.g., the AP 621 of FIG. 8 or 9) may obtain the allowable maximum latency of a client device (e.g., the client device 601 of FIG. 8 or 9) that has requested a TWT negotiation (e.g., the TWT negotiation 60 of FIG. 8) for pre-emption. For example, the AP 621 may obtain the allowable maximum latency from a TWT request frame (e.g., the TWT request frame 1100 of FIG. 10) transmitted from the client device 601.

In operation 1420, the AP 621 may obtain the probability that the client device 601 beats another client device (e.g., the client device 611 of FIG. 8) in the contention for medium access (or medium occupancy). The AP 621 may calculate a winning probability of the client device 601 based on an upper bound of a random backoff of the client device 601 and an upper bound of a random backoff of the other client device 611. Hereinafter, for ease of description, the present disclosure is described focusing on the random backoff without considering an SIFS and/or an AIFSN. For example, when the random backoff upper bound of the client device 601 is 7 slots and the random backoff upper bound of the other client device 611 is 15 slots, the probability (the probability of obtaining a TXOP) that the client device 601 wins one contention may be about 66%.

In operation 1430, the AP 621 may determine the minimum number of competitions required for providing the client device 601 with a TXOP probability that satisfies a threshold probability. For example, the AP 621 may determine the minimum number of competitions ‘n’ such that the probability (or a TXOP probability) that the client device 601 wins at least one of ‘n’ (n is a natural number) competitions is greater than the threshold probability. For example, when the threshold probability is 95% and the client device 601 has a 66% probability of winning one contention, the minimum number of competitions required for the client device 601 may be 3.

In operation 1440, the AP 621 may determine a TXOP limit of the other client device 611 based on the allowable maximum latency of the client device 601 and the minimum number of competitions required for the client device 601. For example, when the allowable maximum latency of the client device 601 is 5 ms and the minimum number of competitions required for the client device 601 is 3, the TXOP limit of the other client device 611 may be approximately 1.66 ms, which is a value obtained by dividing 5 ms by 3.

FIG. 15 is a diagram illustrating an example process of processing a plurality of TWT requests, according to various embodiments. FIG. 15 illustrates a Wi-Fi network in which three client devices 601, 611, and 631 are connected to the AP 621 and the two client devices 601 and 631 try a TWT negotiation for pre-emption. However, this is an example for ease of description, and it will be apparent to one of ordinary skill in the art that the scope of the present disclosure is not limited thereto.

Referring to FIG. 15, according to an embodiment, when the TWT requests for pre-emption are received from each of the plurality of client devices 601 and 631, the AP 621 may reject at least one TWT request. For example, when the AP 621 receives the TWT request for pre-emption from the client device 631 after receiving the TWT request for pre-emption from the client device 601, the AP 621 may reject the TWT request for pre-emption received from the client device 631.

According to an embodiment, when the TWT requests for pre-emption are received from each of the plurality of client devices 601 and 631, the AP 621 may determine a TXOP limit of a contending client device within (or during) a time period T_PD during which respective TWT SPs of the plurality of client devices 601 and 631 overlap each other. For example, the AP 621 may determine a first TXOP limit of a contending client device (e.g., the client device 611) based on the TWT request (e.g., the QoS requirement) from the client device 601, determine a second TXOP limit of a contending client device (e.g., the client device 611) based on the TWT request from the client device 631, and determine, to be the TXOP limit of the contending client device (e.g., the client device 611) within the time period T_PD, a smaller value (or a minimum value when an AP receives a TWT request for pre-emption from three or more client devices) between the first TXOP limit and the second TXOP limit.

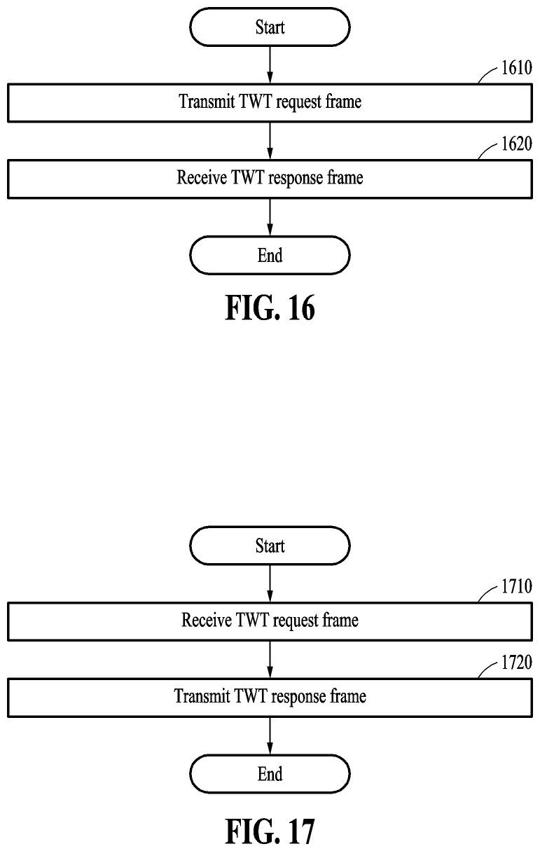

FIG. 16 is a flowchart illustrating an example method of operating an electronic device that operates as a client, according to various embodiments.

Referring to FIG. 16, according to an embodiment, operation 1610 or operation 1620 may be substantially the same as the operation of the client device (e.g., the STA 301 of FIG. 3 or the client device 601 of FIGS. 6 to 9) described with reference to FIGS. 1 to 15, so a description may not be repeated here.

In operation 1610, the electronic devices 301 and 601 may transmit, to an external electronic device (e.g., the AP 401 of FIG. 4 or the AP 621 of FIGS. 6 to 8) broadcasting a Wi-Fi signal, a TWT request frame to determine a TXOP limit of another client device (e.g., the client device 611 of FIGS. 6 to 9) in a BSS including the external electronic device and an electronic device communicatively connected to the external electronic device.

In operation 1620, the electronic device may receive a TWT response frame corresponding to the TWT request frame transmitted from the external electronic device.

FIG. 17 is a flowchart illustrating an example method of operating an electronic device that operates as an AP, according to various embodiments.

Referring to FIG. 17, according to an embodiment, operation 1710 or operation 1720 may be substantially the same as the operation of the AP (e.g., the AP 401 of FIG. 3 or the AP 621 of FIGS. 6 to 8) described with reference to FIGS. 1 to 15, so a description may not be repeated here.

In operation 1710, the electronic devices, that is, the AP 401 and the AP 621, may receive, from an external electronic device (e.g., the STA 301 of FIG. 3 or the client device 601 of FIGS. 6 to 9) communicatively connected to an electronic device, a TWT request frame to determine a TXOP limit of another client device (e.g., the client device 611 of FIGS. 6 to 9) in a BSS including the electronic device and the external electronic device.

In operation 1720, the electronic device may transmit, to the external electronic device, a TWT response frame corresponding to the received TWT request frame.

FIG. 18 is a block diagram illustrating an example electronic device 1801 (e.g., the STA 301 of FIG. 3 or the client device 601 of FIGS. 6 to 9) in a network environment 1000, according to various embodiments.

Referring to FIG. 18, in the network environment 1000, the electronic device 1801 may communicate with an electronic device 1802 (e.g., the AP 401 of FIG. 3 or the AP 621 of FIGS. 6 to 8) through a first network 1898 (e.g., a short-range wireless communication network), or may communicate with at least one of an electronic device 1804 or a server 1808 through a second network 1899 (e.g., a long-range wireless communication network). According to an embodiment, the electronic device 1801 may communicate with the electronic device 1804 via the server 1808. According to an embodiment, the electronic device 1801 may include a processor 1820, a memory 1830, an input module 1850, a sound output module 1855, a display module 1860, an audio module 1870, and a sensor module 1876, an interface 1877, a connecting terminal 1878, a haptic module 1879, a camera module 1880, a power management module 1888, a battery 1889, a communication module 1890, a subscriber identification module (SIM) 1896, or an antenna module 1897. In various embodiments, at least one of the components (e.g., the connecting terminal 1878) may be omitted from the electronic device 1801, or one or more other components may be added to the electronic device 1801. In various embodiments, some of the components (e.g., the sensor module 1876, the camera module 1880, or the antenna module 1897) may be integrated as a single component (e.g., the display module 1860).

The processor 1820 may execute, for example, software (e.g., a program 1840) to control at least one other component (e.g., a hardware or software component) of the electronic device 1801 connected to the processor 1820 and may perform various data processing or computations. According to an embodiment, as at least part of data processing or computation, the processor 1820 may store a command or data received from another component (e.g., the sensor module 1876 or the communication module 1890) in a volatile memory 1832, process the command or the data stored in the volatile memory 1832, and store resulting data in a non-volatile memory 1834. According to an embodiment, the processor 1820 may include a main processor 1821 (e.g., a central processing unit (CPU) or an application processor (AP)) or an auxiliary processor 1823 (e.g., a graphics processing unit (GPU), a neural processing unit (NPU), an image signal processor (ISP), a sensor hub processor, or a communication processor (CP)) that is operable independently of, or in conjunction with the main processor 1821. For example, when the electronic device 1801 includes the main processor 1821 and the auxiliary processor 1823, the auxiliary processor 1823 may be adapted to consume less power than the main processor 1821 or to be specific to a specified function. The auxiliary processor 1823 may be implemented separately from the main processor 1821 or as a part of the main processor 1821. Thus, the processor 1820 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1823 may control at least some of functions or states related to at least one (e.g., the display module 1860, the sensor module 1876, or the communication module 1890) of the components of the electronic device 1801, instead of the main processor 1821 while the main processor 1821 is in an inactive (e.g., sleep) state or along with the main processor 1821 while the main processor 1821 is an active state (e.g., executing an application). According to an embodiment, the auxiliary processor 1823 (e.g., an ISP or a CP) may be implemented as a portion of another component (e.g., the camera module 1880 or the communication module 1890) that is functionally related to the auxiliary processor 1823. According to an embodiment, the auxiliary processor 1823 (e.g., an NPU) may include a hardware structure specified for artificial intelligence model processing. The AI model may be generated by machine learning. The machine learning may be performed by, for example, the electronic device 1801, in which artificial intelligence is performed, or performed via a separate server (e.g., the server 1808). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 1830 may store various pieces of data used by at least one component (e.g., the processor 1820 or the sensor module 1876) of the electronic device 1801. The various pieces of data may include, for example, software (e.g., the program 1840) and input data or output data for a command related thereto. The memory 1830 may include the volatile memory 1832 or the non-volatile memory 1834. According to an embodiment, when the instructions stored in the memory 1830 are individually or collectively executed by at least one processor (e.g., the main processor 1821 and/or the auxiliary processor 1823), the instructions may cause the electronic device 1801 to perform at least one instruction. For example, the instructions stored in the memory 1830 may be executed by one processor (e.g., the main processor 1821 or the auxiliary processor 1823 such as a CP) or may be executed by a plurality of processors (e.g., the main processor 1821 and the auxiliary processor 1823) operating cooperatively.

The program 1840 may be stored as software in the memory 1830 and may include, for example, an operating system (OS) 1842, middleware 1844, or an application 1846.

The input module 1850 may receive, from outside (e.g., a user) the electronic device 1801, a command or data to be used by another component (e.g., the processor 1820) of the electronic device 1801. The input module 1850 may include, for example, a microphone, a mouse, a keyboard, a key (e.g., a button), or a digital pen (e.g., a stylus pen).

The sound output module 1855 may output a sound signal to the outside of the electronic device 1801. The sound output module 1855 may include, for example, a speaker or a receiver. The speaker may be used for general purposes, such as playing multimedia or playing record. The receiver may be used to receive an incoming call. According to an embodiment, the receiver may be implemented separately from the speaker or as a part of the speaker.

The display module 1860 may visually provide information to the outside (e.g., a user) of the electronic device 1801. The display module 1860 may include, for example, a display, a hologram device, or a projector and control circuitry to control a corresponding one of the display, the hologram device, and the projector. According to an embodiment, the display module 1860 may include a touch sensor adapted to sense a touch, or a pressure sensor adapted to measure an intensity of a force incurred by the touch.

The audio module 1870 may convert a sound into an electric signal and vice versa. According to an embodiment, the audio module 1870 may obtain the sound via the input module 1850 or output the sound via the sound output module 1855 or an external electronic device (e.g., the electronic device 1802 such as a speaker or a headphone) directly or wirelessly coupled with the electronic device 1801.

The sensor module 1876 may detect an operational state (e.g., power or temperature) of the electronic device 1801 or an environmental state (e.g., a state of a user) external to the electronic device 1801, and generate an electrical signal or data value corresponding to the detected state. According to an embodiment, the sensor module 1876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1877 may support one or more specified protocols to be used for the electronic device 1801 to be coupled with the external electronic device (e.g., the electronic device 1802) directly (e.g., by wire) or wirelessly. According to an embodiment, the interface 1877 may include, for example, a high-definition multimedia interface (HDMI), a universal serial bus (USB) interface, a secure digital (SD) card interface, or an audio interface.

The connecting terminal 1878 may include a connector via which the electronic device 1801 may be physically connected to an external electronic device (e.g., the electronic device 1802). According to an embodiment, the connecting terminal 1878 may include, for example, an HDMI connector, a USB connector, an SD card connector, or an audio connector (e.g., a headphone connector).

The haptic module 1879 may convert an electric signal into a mechanical stimulus (e.g., a vibration or a movement) or an electrical stimulus which may be recognized by a user via his or her tactile sensation or kinesthetic sensation. According to an embodiment, the haptic module 1879 may include, for example, a motor, a piezoelectric element, or an electric stimulator.

The camera module 1880 may capture a still image and moving images. According to an embodiment, the camera module 1880 may include one or more lenses, image sensors, ISPs, or flashes.

The power management module 1888 may manage power supplied to the electronic device 1801. According to an embodiment, the power management module 1888 may be implemented as, for example, at least a part of a power management integrated circuit (PMIC).

The battery 1889 may supply power to at least one component of the electronic device 1801. According to an embodiment, the battery 1889 may include, for example, a primary cell which is not rechargeable, a secondary cell which is rechargeable, or a fuel cell.

The communication module 1890 may support establishing a direct (e.g., wired) communication channel or a wireless communication channel between the electronic device 1801 and the external electronic device (e.g., the electronic device 1802, the electronic device 1804, or the server 1808) and performing communication via the established communication channel. The communication module 1890 may include one or more CPs that are operable independently of the processor 1820 (e.g., an AP) and that support a direct (e.g., wired) communication or a wireless communication. According to an embodiment, the communication module 1890 may include a wireless communication module 1892 (e.g., a cellular communication module, a short-range wireless communication module, or a global navigation satellite system (GNSS) communication module) or a wired communication module 1894 (e.g., a local area network (LAN) communication module, or a power line communication (PLC) module). A corresponding one of these communication modules may communicate with the external electronic device 1804 via the first network 1898 (e.g., a short-range communication network, such as Bluetooth™, wireless-fidelity (Wi-Fi) direct, or infrared data association (IrDA)) or the second network 1899 (e.g., a long-range communication network, such as a legacy cellular network, a fifth generation (5G) network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 1892 may identify and authenticate the electronic device 1801 in a communication network, such as the first network 1898 or the second network 1899, using subscriber information (e.g., international mobile subscriber identity (IMSI)) stored in the SIM 1896.

The wireless communication module 1892 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1892 may support a high-frequency band (e.g., a mmWave band) to achieve, e.g., a high data transmission rate. The wireless communication module 1892 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 1892 may support various requirements specified in the electronic device 1801, an external electronic device (e.g., the electronic device 1804), or a network system (e.g., the second network 1899). According to an embodiment, the wireless communication module 1892 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1897 may transmit or receive a signal or power to or from the outside (e.g., an external electronic device) of the electronic device 1801. According to an embodiment, the antenna module 1897 may include an antenna including a radiating element including a conductive material or a conductive pattern formed in or on a substrate (e.g., a printed circuit board (PCB)). According to an embodiment, the antenna module 1897 may include a plurality of antennas (e.g., array antennas). In such a case, at least one antenna appropriate for a communication scheme used in a communication network, such as the first network 1898 or the second network 1899, may be selected by, for example, the communication module 1890 from the plurality of antennas. The signal or power may be transmitted or received between the communication module 1890 and the external electronic device via the at least one selected antenna. According to an embodiment, another component (e.g., a radio frequency integrated circuit (RFIC)) other than the radiating element may be additionally formed as a part of the antenna module 1897.

According to an embodiment, the antenna module 1897 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1801 and the external electronic device 1804 via the server 1808 coupled with the second network 1899. Each of the external electronic devices (1802 or 1804) may be the same or a different type of device as the electronic device 1801. According to an embodiment, all or some of operations to be executed by the electronic device 1801 may be executed at one or more external electronic devices (e.g., the external devices 1802 and 1804, or the server 1808). For example, if the electronic device 1801 needs to perform a function or a service automatically, or in response to a request from a user or another device, the electronic device 1801, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 1801. The electronic device 1801 may provide the outcome, with or without further processing of the outcome, as at least part of a reply to the request. To that end, a cloud computing, distributed computing, mobile edge computing (MEC), or client-server computing technology may be used, for example. The electronic device 1801 may provide ultra low-latency services using, e.g., distributed computing or MEC. In an embodiment, the external electronic device 1804 may include an Internet-of-things (IoT) device. The server 1808 may be an intelligent server using machine learning and/or a neural network. According to an embodiment, the external electronic device 1804 or the server 1808 may be included in the second network 1899. The electronic device 1801 may be applied to intelligent services (e.g., a smart home, a smart city, a smart car, or healthcare) based on 5G communication technology or IoT-related technology.

According to an embodiment, an electronic device (301, 601, 1801) may include at least one processor (1820) including processing circuitry and memory (1830) storing instructions that, when executed by the at least one processor (1820) individually or collectively, cause the electronic device (301, 601, 1801) to transmit, to an external electronic device (401, 621, 1802) broadcasting a wireless fidelity (Wi-Fi) signal, a target wake time (TWT) request frame (1100) to determine a transmission opportunity (TXOP) limit of another client device (611) in a basic service set (BSS) including the external electronic device (401, 621, 1802) and the electronic device (301, 601, 1801) communicatively connected to the external electronic device (401, 621, 1802), wherein the instructions, when executed by the at least one processor (1820) individually or collectively, cause the electronic device (301, 601, 1801) to receive, from the external electronic device (401, 621, 1802), a TWT response frame corresponding to the TWT request frame (1100).

The TWT request frame (1100) may include information to determine the TXOP limit of the other client device (611) during a TWT service period (SP) of the electronic device (301, 601, 1801).

The external electronic device (401, 621, 1802) may be configured to provide the determined TXOP limit to the other client device (611).

The TWT request frame (1100) may include a field including information indicating that a TWT negotiation by the TWT request frame (1100) is a TWT type to determine the TXOP limit, not an individual TWT or a broadcast TWT.

The TWT request frame (1100) may include quality of service (QoS) requirement information of the electronic device (301, 601, 1801).

The external electronic device (401, 621, 1802) may be configured to determine, based on the QoS requirement information included in the TWT request frame (1100), a probability that the electronic device (301, 601, 1801) wins a contention with the other client device (611) to obtain a TXOP.

The external electronic device (401, 621, 1802) may be configured to determine, based on the probability, the minimum number of competitions with the other client device (611), which is necessary to provide the electronic device (301, 601, 1801) with a TXOP probability that is greater than a threshold probability.

The probability may be determined based on a random backoff upper bound for traffic of the electronic device (301, 601, 1801) and a random backoff upper bound for traffic of the other client device (611).

The QoS requirement information may include the maximum allowable latency for the traffic of the electronic device (301, 601, 1801).

According to an embodiment, an electronic device (401, 621, 1802) for broadcasting a Wi-Fi signal may include at least one processor (1820) including processing circuitry and memory (1830) storing instructions that, when executed by the at least one processor (1820) individually or collectively, cause the electronic device (401, 621, 1802) to receive, from an external electronic device (301, 601, 1801) communicatively connected to the electronic device (401, 621, 1802), a TWT request frame (1100) to determine a TXOP limit of another client device (611) in a BSS including the electronic device (401, 621, 1802) and the external electronic device (301, 601, 1801), wherein the instructions, when executed by the at least one processor (1820) individually or collectively, cause the electronic device (401, 621, 1802) to transmit, to the external electronic device (301, 601, 1801), a TWT response frame corresponding to the TWT request frame (1100).

The TWT request frame (1100) may include information to determine the TXOP limit of the other client device (611) during a TWT SP of the external electronic device (301, 601, 1801).

The instructions, when executed by the at least one processor (1820) individually or collectively, may cause the electronic device (401, 621, 1802) to provide the determined TXOP limit to the other client device (611).

The TWT request frame (1100) may include a field including information indicating that a TWT negotiation by the TWT request frame (1100) is a TWT type to determine the TXOP limit, not an individual TWT or a broadcast TWT.

The TWT request frame (1100) may include QoS requirement information of the external electronic device (301, 601, 1801).

The instructions, when executed by the at least one processor (1820) individually or collectively, may cause the electronic device (401, 621, 1802) to determine, based on the QoS requirement information included in the TWT request frame (1100), a probability that the external electronic device (301, 601, 1801) wins a contention with the other client device (611) to obtain a TXOP.

The instructions, when executed by the at least one processor (1820) individually or collectively, may cause the electronic device (401, 621, 1802) to determine, based on the probability, the minimum number of competitions with the other client device (611), which is necessary to provide the external electronic device (301, 601, 1801) with a TXOP probability that is greater than a threshold probability.

The instructions, when executed by the at least one processor (1820) individually or collectively, may cause the electronic device (401, 621, 1802) to determine the probability based on a random backoff upper bound for traffic of the external electronic device (301, 601, 1801) and a random backoff upper bound for traffic of the other client device (611).

The QoS requirement information may include the maximum allowable latency for the traffic of the external electronic device (301, 601, 1801).

According to an embodiment, an method performed by an electronic device (301, 601, 1801) may include transmitting, to an external electronic device (401, 621, 1802) broadcasting a Wi-Fi signal, a TWT request frame (1100) to determine a TXOP limit of another client device (611) in a BSS including the external electronic device (401, 621, 1802) and the electronic device (301, 601, 1801) communicatively connected to the external electronic device (401, 621, 1802) and receiving, from the external electronic device (401, 621, 1802), a TWT response frame corresponding to the TWT request frame (1100).

The electronic device according to various embodiments disclosed herein may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic device is not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., by wire), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 1840) including one or more instructions that are stored in a storage medium (e.g., an internal memory 1836 or an external memory 1838) that is readable by a machine (e.g., the electronic device 1801). For example, a processor (e.g., the processor 1820) of the machine (e.g., the electronic device 1801) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
at least one processor, including processing circuitry,
memory storing instructions, wherein at least one processor, individually or collectively, is configured to execute the instructions and to cause the electronic device to:
transmit, to an external electronic device broadcasting a wireless fidelity (Wi-Fi) signal, a target wake time (TWT) request frame to determine a transmission opportunity (TXOP) limit of another client device in a basic service set (BSS) comprising the external electronic device and the electronic device communicatively connected to the external electronic device, and
receive, from the external electronic device, a TWT response frame corresponding to the TWT request frame.

2. The electronic device of claim 1, wherein the TWT request frame comprises information to determine the TXOP limit of the other client device during a TWT service period (SP) of the electronic device.

3. The electronic device of claim 1, wherein the external electronic device is configured to provide the determined TXOP limit to the other client device.

4. The electronic device of claim 1, wherein the TWT request frame comprises a field comprising information indicating that a TWT negotiation by the TWT request frame is a TWT type to determine the TXOP limit, not an individual TWT or a broadcast TWT.

5. The electronic device of claim 1, wherein the TWT request frame comprises quality of service (QoS) requirement information of the electronic device.

6. The electronic device of claim 1, wherein the external electronic device is configured to determine, based on the QoS requirement information comprised in the TWT request frame, a probability that the electronic device wins a contention with the other client device to obtain a TXOP.

7. The electronic device of claim 6, wherein the external electronic device is configured to determine, based on the probability, a minimum number of competitions with the other client device, which is necessary to provide the electronic device with a TXOP probability greater than a threshold probability.

8. The electronic device of claim 6, wherein the probability is determined based on a random backoff upper bound for traffic of the electronic device and a random backoff upper bound for traffic of the other client device.

9. The electronic device of claim 5, wherein the QoS requirement information comprises a maximum allowable latency for the traffic of the electronic device.

10. An electronic device for broadcasting a wireless fidelity (Wi-Fi) signal, the electronic device comprising:
at least one processor, including processing circuitry,
memory storing instructions, wherein at least one processor, individually or collectively, is configured to execute the instructions and to cause the electronic device to:
receive, from an external electronic device communicatively connected to the electronic device, a target wake time (TWT) request frame to determine a transmission opportunity (TXOP) limit of another client device in a basic service set (BSS) comprising the electronic device and the external electronic device, and
transmit, to the external electronic device, a TWT response frame corresponding to the TWT request frame.

11. The electronic device of claim 10, wherein the TWT request frame comprises information to determine the TXOP limit of the other client device during a TWT service period (SP) of the external electronic device.

12. The electronic device of claim 10, wherein at least one processor, individually or collectively, is configured to cause the electronic device to provide the determined TXOP limit to the other client device.

13. The electronic device of claim 10, wherein the TWT request frame comprises a field comprising information indicating that a TWT negotiation by the TWT request frame is a TWT type to determine the TXOP limit, not an individual TWT or a broadcast TWT.

14. The electronic device of claim 10, wherein the TWT request frame comprises quality of service (QoS) requirement information of the external electronic device.

15. The electronic device of claim 14, wherein at least one processor, individually or collectively, is configured to cause the electronic device to determine, based on the QoS requirement information comprised in the TWT request frame, a probability that the external electronic device wins a contention with the other client device to obtain a TXOP.

16. The electronic device of claim 15, wherein at least one processor, individually or collectively, is configured to cause the electronic device to determine, based on the probability, a minimum number of competitions with the other client device, which is necessary to provide the external electronic device with a TXOP probability greater than a threshold probability.

17. The electronic device of claim 15, wherein at least one processor, individually or collectively, is configured to cause the electronic device to determine the probability based on a random backoff upper bound for traffic of the external electronic device and a random backoff upper bound for traffic of the other client device.

18. The electronic device of claim 14, wherein the QoS requirement information comprises a maximum allowable latency for the traffic of the external electronic device.

19. A method performed by an electronic device, the method comprising:
transmitting, to an external electronic device broadcasting a wireless fidelity (Wi-Fi) signal, a target wake time (TWT) request frame to determine a transmission opportunity (TXOP) limit of another client device in a basic service set (BSS) comprising the external electronic device and the electronic device communicatively connected to the external electronic device, and
receiving, from the external electronic device, a TWT response frame corresponding to the TWT request frame.

20. A non-transitory computer-readable storage medium storing instructions that, when executed by at least one processor, comprising processing circuitry, of an electronic device, individually and/or collectively, cause the electronic device to perform the method of claim 19.
